(19) United States
(12) Patent Application Publication
(10) Pub. No.: US 2022/0055314 A1
(43) Pub. Date: Feb. 24, 2022

(54) PROCESS FOR THE PRODUCTION OF COMPOSITE MADE OF COOLING PLATE AND STRUCTURAL COMPONENT

(71) Applicant: Mahle International GmbH, Stuttgart (DE)

(72) Inventor: Thomas Schiehlen, Eislingen (DE)

(21) Appl. No.: 17/408,420

(22) Filed: Aug. 21, 2021

(30) Foreign Application Priority Data
Aug. 21, 2020 (DE) 10 2020 210 660.6

(51) Int. Cl. B29C 65/48; F28F 3/12; H01M 10/613; B29C 65/00; H01M 10/625

(52) U.S. Cl. CPC B29C 65/4815; F28F 3/12; H01M 10/613; B29L 2031/18; H01M 10/625; F28F 2275/025; B29C 66/723

(57) ABSTRACT

A process for producing a composite. The process may include providing a cooling plate through which a temperature-control fluid is flowable, providing a structural component that is coolable via the cooling plate, and fixing and thermal coupling the cooling plate and the structural component to one another via full-surface adhesive bonding the cooling plate and the structural component to one another. Full-surface adhesive bonding the cooling plate and the structural component to one another may include arranging an adhesive in a joint disposed between the cooling plate and the structural component.

### CROSS-REFERENCE TO RELATED APPLICATIONS

This application claims priority to German Patent Application No. DE 10 2020 210 660.6, filed on Aug. 21, 2020, the contents of which is hereby incorporated by reference in its entirety.

### TECHNICAL FIELD

The invention relates to a process for the production of a composite made of a cooling plate and of a structural component, and also to a composite produced by means of the said process.

### BACKGROUND

Electrical vehicle batteries in motor vehicles have long been cooled by means of a cooling plate through which a temperature-control fluid can flow. The battery housing of the vehicle battery here can, or is intended to, contribute to the overall structural rigidity of the vehicle, and the battery housing therefore forms a structural component. This type of structural component and this type of cooling plate are typically arranged in a composite which comprises the structural component and the cooling plate. In production processes for the production of this type of composite, the cooling plate and the structural component are usually fixed to one another by means of soldering, welding, adhesive bonding or clinching or the like, and thermally coupled to one another so that, by means of the temperature-control fluid flowing through the cooling plate, heat can be absorbed from the structural component and transported away from the structural component.

When the cooling plate and the structural component are bonded to one another by means of soldering or welding, in the case of conventional production processes and/or in the case of composites produced by means of a conventional production process of this type, it proves to be disadvantageous that a dependable bond between the cooling plate and the structural component can be achieved only by using identical, or at least similar, material for the cooling plate and the structural component. This considerably restricts the combinations of material that can be used. The material of the cooling plate and/or of the structural component is moreover typically mechanically weakened as a consequence of the heat introduced during the welding and/or soldering procedure. Furthermore, the heat required for the welding and/or soldering procedure gives rise to an increased energy cost that has to be incurred for the production of the bond between the structural component and the cooling plate.

When the cooling plate and the structural component are bonded to one another by means of adhesive bonding, it is disadvantageously impossible or difficult to ensure that the quantity of adhesive used is sufficiently great but nevertheless not excessive. In short, it is difficult to achieve optimized metering of adhesive. When conventional production processes are used, in which the composite is produced by means of adhesive bonding, air inclusions in the adhesive joint, or cavitation, can moreover occur, with resultant impairment of the strength of the adhesive bond and of the desired thermal coupling between the structural component and the cooling plate. The adhesive bond between the structural component and the cooling plate must moreover be heat-resistant up to about 120° C. and have long-term stability at about 80° C. Furthermore, the adhesive bond is subject to stringent requirements in relation to its solvent resistance, in particular if a water-Glysantin mixture is used as temperature-control fluid.

### SUMMARY

It is therefore an object of the present invention—in particular in order to eliminate the disadvantages indicated above—to indicate novel methods for processes for the production of a composite with a cooling plate and with a structural component, and also for composites produced by means of such a process.

The underlying concept of the invention is accordingly, for the fixing and thermal coupling of the cooling plate and of the structural component to one another in a process for the production of a composite with a cooling plate and with a structural component, to use in essence full-surface adhesive bonding between the cooling plate and the structural component.

The adhesive bonding advantageously also allows the production of a composite with a combination of materials of the cooling plate and of the structural component that is in principle not weldable and/or solderable, thus allowing achievement of greater, and in most cases less expensive, freedom in the selection of the said materials. The full-surface adhesive bonding also achieves particularly dependable fixing of the cooling plate and of the structural component to one another, and at the same time particularly good thermal coupling between the cooling plate and the structural component.

A process of the invention for the production of a composite with a cooling plate and with a structural component amenable to cooling by means of the cooling plate comprises the measures a), b) and c) explained below. The composite here is preferably suitable for a motor vehicle and/or can be part of a motor vehicle. This type of motor vehicle can be a car or a lorry or any other vehicle used to carry goods or passengers.

According to a first measure a) of the process, the cooling plate through which a temperature-control fluid can flow is provided. The temperature-control fluid is preferably a temperature-control liquid. The process moreover comprises a second measure b), according to which the structural component is provided. Furthermore, the process comprises a third measure c), according to which the cooling plate and the structural component are in essence full-surface adhesive-bonded to one another by means of an adhesive. In measure c) here, the adhesive for the fixing and thermal coupling of the cooling plate and of the structural component to one another is arranged in a joint that is present between the cooling plate and the structural component. It is thus advantageously possible that cooling plate and structural component made of different materials are dependably bonded to one another. It moreover permits full-surface adhesive bonding, which is thus free from defects that can be present when conventional processes are used, as a consequence of air inclusions or cavities in the adhesive, thus permitting achievement of particularly dependable fixing of the cooling plate and of the structural component to one another, and also of particularly effective thermal coupling between the cooling plate and the structural component. In addition to the above, the process of the invention is notable for particularly low energy cost from the production of the composite. It is also possible to keep introduction of heat into the material of the cooling plate and/or of the structural component to a low level.

According to a preferred further development of the process, before conduct of the third measure c), the adhesive is applied with a layer thickness between 5 and 500 μm, preferably between 10 and 100 μm, to a joint-delimiting joint area of the cooling plate and/or of the structural component. It is thus advantageously possible firstly to ensure complete wetting of the joint area with adhesive, this being a requirement for the full-surface adhesive bonding, and secondly to avoid use of an unnecessarily large quantity of adhesive, with resultant wastefulness that increases costs. The small layer thickness moreover ensures particularly good thermal coupling between the structural component and the cooling plate.

In an advantageous further development of the process, an adhesive based on epoxy resin or based on polyurethane or based on silicone is used. This type of adhesive proves advantageously to be particularly inexpensive.

Another preferred further development of the process provides that a material of the structural component and a material of the cooling plate have an in essence identical coefficient of thermal expansion, in particular when an adhesive based on epoxy resin is used. It is thus possible to achieve effective avoidance, or at least reduction, of thermally induced mechanical stresses in the adhesive joint of the composite, because it is ensured that in the event of a temperature change the cooling plate and the structural component in essence merely expand or contract to an identical extent.

In another advantageous further development of the process, an adhesive based on polyolefin is used. This polyolefin base preferably comprises polyethylene, polypropylene or polybutylene or a combination of at least two of these materials. This type of adhesive can advantageously provide an elastic adhesive bond, so that different thermal expansions of the cooling plate and of the structural component can be better compensated without failure of the adhesive bond.

According to another preferred further development of the process, the material of the structural component and the material of the cooling plate have different or identical coefficients of thermal expansion, in particular when an adhesive based on polyolefin and/or a hot-melt adhesive is used. It is thus possible to realize the structural component and the cooling plate with different materials; this can reduce costs for the material of the composite, and increases design freedom.

According to another advantageous further development of the process, the adhesive is introduced in the form of a film into the joint. It is thus possible to apply the adhesive with particular precision, while at the same time there is no requirement for metering devices that are typically maintenance-intensive and expensive to purchase, for example pumps, valves or nozzles.

In another preferred further development of the process, the film has been cut to size before it is inserted between the joint-delimiting joint areas of the structural component and of the cooling plate. This prior cutting-to-size of the film is preferably achieved by cutting the film to size so that its area matches the area of the joint. This allows even more precise metering of the adhesive.

According to another advantageous further development of the process, before conduct of the measure c) at least one of the joint-delimiting joint areas is full-surface-coated with adhesive. It is thus advantageously possible to achieve particularly dependable avoidance of possible defects in the adhesive joint.

Another preferred further development of the process provides that the structural component comprises, or is, an electrical battery cell or a battery housing for an electrical battery or power electronics or a power-electronics housing for power electronics. In structural components of this type it is possible to achieve particularly good utilization of the advantages indicated above for the process.

In another advantageous further development of the process, the cooling plate comprises at least one channelled metal sheet with at least one fluid channel for conducting the temperature-control fluid. The fluid channel here is configured as groove-like depression in the channelled metal sheet. In particular, the possibility of flow of the temperature-control fluid through the cooling plate can thus be particularly easily realized.

According to another preferred further development of the process, in the direction towards the joint, the at least one fluid channel permits fluid flow or is sealed by means of a metal covering sheet of the cooling plate. This improves the conduct of the temperature-control fluid through the cooling plate.

In another preferred further development of the process, before the adhesive bonding according to the third measure c) with production of the cooling plate, the metal covering sheet of the cooling plate is coherently bonded to the channelled metal sheet of the cooling plate in the direction facing away from the joint. It is preferable here that the metal covering sheet and the channelled metal sheet are soldered or welded or adhesive-bonded to one another. This type of cooling plate proves to be particularly mechanically stable; this has an advantageous effect on the composite comprising the cooling plate.

The invention moreover relates, in particular for a motor vehicle, to a composite which comprises a cooling plate through which a temperature-control fluid can flow. It is preferable that the temperature-control fluid is a temperature-control liquid. The composite moreover comprises a structural component which is amenable to cooling by means of the cooling plate. The composite here has been produced by means of a process described above of the invention. The advantages indicated above for the process of the invention therefore also apply to the composite of the invention, produced by means of the process.

Further important features and advantages of the invention are provided by the dependent claims, by the drawings and by the associated description of the figures with reference to the drawings.

It is self-evident that the abovementioned features and the features that will be explained below can be used not only in the respective combination stated but also in other combinations, or alone, without exceeding the scope of the present invention.

Preferred performance examples of the invention are depicted in the drawings and are explained in more detail in the description below, where identical reference signs relate to identical or similar or functionally identical components.

### BRIEF DESCRIPTION OF THE DRAWINGS

The diagrams show the following:

FIG. 1 shows a sectional depiction of an example of a composite of the invention, produced by means of a process of the invention,

FIG. 2 shows, by way of example, a flow diagram of a process of the invention for the production of a composite.

### DETAILED DESCRIPTION

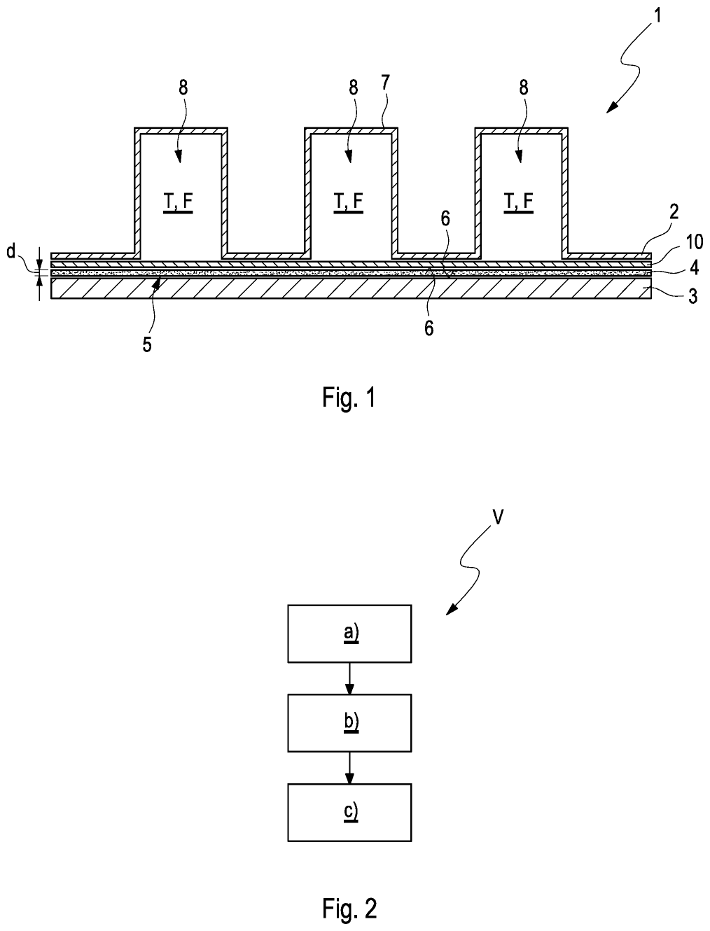

FIG. 1 is a generalized diagram of a section of an example of a composite 1 of the invention. The composite 1 can by way of example be suitable for use in a motor vehicle. The composite 1 comprises a cooling plate 2, through which a temperature-control fluid T can flow. The temperature-control fluid T in the example shown is a temperature-control liquid F. The composite 1 moreover comprises a structural component 3, which can be cooled by means of temperature-control fluid T, which is conducted through the cooling plate 2. The cooling plate 2 comprises at least one channelled metal sheet 7—in the example shown precisely one channelled metal sheet 7—which is provided with at least one fluid channel 8 for conducting the temperature-control fluid T through the cooling plate 2. The fluid channel 8 here is by way of example configured as groove-like depression 9 in the channelled metal sheet 7.

The cooling plate 2 in the example of FIG. 1 moreover comprises a metal covering sheet 10, by means of which the fluid channel 8 is sealed to prevent fluid flow in the direction towards the joint 5. However, in an alternative not shown in the figures it is also possible that this type of metal covering sheet 10 is omitted. The composite 1 here has been produced by means of a process V of the invention, which is explained in more detail below.

FIG. 2 illustrates by way of example a flow diagram of the process V of the invention for the production of a composite 1 of the type shown by way of example in FIG. 1. Accordingly, the process V comprises three measures a) to c). According to a first measure a), a cooling plate 2 is provided, through which a temperature-control fluid T can flow, which by way of example is a temperature-control liquid F. A second measure b) of the process V provides that a structural component 3 of the required composite 1 is provided. A third measure c) achieves in essence full-surface adhesive bonding of the cooling plate 2 and of the structural component 3 to one another by means of an adhesive 4. For the fixing and thermal coupling of the cooling plate 2 and of the structural component 3 to one another, the adhesive 4 here is arranged in a joint 5 that is present between the cooling plate 2 and the structural component 3.

In a variant of the process V here, before conduct of the measure c), the adhesive 4 is applied with a layer thickness d between 5 and 500 μm to a joint-5-delimiting joint area 6 of the cooling plate 2. The joint area 6 on which the adhesive 4 is applied can be present on the cooling plate 2, and also—alternatively or additionally—on the structural component 3. By way of example, a crosslinking adhesive 4 is used, based for example on epoxy resin, on polyurethane or on silicone. In this case it is possible that a material of the structural component 3 and a material of the cooling plate 2 have a coefficient of thermal expansion that is in essence identical.

In an alternative variant of the process V, an adhesive 4 based on polyolefin is used. The polyolefin base can comprise polyethylene, polypropylene or polybutylene, or a combination thereof. The adhesive 4 is by way of example a hot-melt adhesive. In this case, the material of the structural component 3 and the material of the cooling plate 2 can have different or identical coefficients of thermal expansion. The adhesive 4 is, for example, introduced in the form of a film into the joint 5. By way of example, the film has been cut to size before it is inserted between the joint-5-delimiting joint areas 6 of the structural component 3 and of the cooling plate 2. This means that before the film is inserted into the joint 5 it can be cut to size to match the joint areas 6. The film can have been laminated on the respective joint area 6. During the adhesive bonding according to the third measure c), the cooling plate 2 and the structural component 3 can be pressed together, for example at 0.1 to 0.7 N/mm², after the adhesive 4 or the film has been melted, or during melting of the adhesive 4 or of the film.

According to the process V, by way of example, before conduct of the third measure c) at least one of the joint-5-delimiting joint areas 6 is advantageously full-surface-coated with adhesive 4. The structural component 3 comprises by way of example an electrical battery cell or a battery housing for an electrical battery or power electronics or a power-electronics housing for power electronics, or is an electrical battery cell or a battery housing for an electrical battery or power electronics or a power-electronics housing for power electronics.

For example, before the adhesive bonding according to the third measure c) with production of the cooling plate 2, the metal covering sheet 10 of the cooling plate 2 is coherently bonded to the channelled metal sheet 7 of the cooling plate 2 in the direction facing away from the joint 5. The metal covering sheet 10 and the channelled metal sheet 7 can be soldered or welded or adhesive-bonded to one another.

1. A process for producing a composite, the process comprising:
providing a cooling plate through which a temperature-control fluid is flowable;
providing a structural component that is coolable via the cooling plate,
fixing and thermal coupling the cooling plate and the structural component to one another via, in essence, full-surface adhesive bonding the cooling plate and the structural component to one another; and
wherein full-surface adhesive bonding the cooling plate and the structural component to one another includes arranging an adhesive in a joint disposed between the cooling plate and the structural component.

2. The process according to claim 1, further comprising, before fixing and thermal coupling the cooling plate and the structural component to one another, applying the adhesive with a layer thickness of 5 to 500 micrometres to at least one of (i) a joint-delimiting joint area of the cooling plate and (ii) a joint-delimiting joint area of the structural component.

3. The process according to claim 1, wherein the adhesive is configured as a crosslinking adhesive based on at least one of (i) epoxy resin, (ii) polyurethane, and (iii) silicone.

4. The process according to claim 3, wherein a material of the structural component and a material of the cooling plate each have a coefficient of thermal expansion that is, in essence, identical.

5. The process according to claim 1, wherein the adhesive is based on polyolefin.

6. The process according to claim 1, wherein the adhesive is configured as a hot-melt adhesive.

7. The process according to claim 5, wherein a material of the structural component and a material of the cooling plate each have a different coefficient of thermal expansion.

8. The process according to claim 3, wherein:
the adhesive is structured as an adhesive film; and
arranging the adhesive in the joint includes introducing the adhesive film into the joint.

9. The process according to claim 8, further comprising cutting the adhesive film to size before introducing the adhesive film into the joint; and
wherein introducing the adhesive film into the joint includes inserting the adhesive film between a joint-delimiting joint area of the structural component and a joint-delimiting joint area of the cooling plate.

10. The process according to claim 1, further comprising, before fixing and thermal coupling the cooling plate and the structural component to one another, full-surface-coating at least one of (i) a joint-delimiting joint area of the cooling plate and (ii) a joint-delimiting joint area of the structural component with the adhesive.

11. The process according to claim 1, wherein the structural component is configured as at least one of an electrical battery cell, a battery housing, and a power-electronics housing for at least one of an electrical battery and a power electronics.

12. The process according to claim 1, wherein:
the cooling plate includes at least one channelled metal sheet having at least one fluid channel for conducting the temperature-control fluid; and
the at least one fluid channel is defined at least partially by a groove-like depression disposed in the at least one channelled metal sheet.

13. The process according to claim 12, wherein, in a direction towards the joint, the at least one fluid channel at least one of:
permits fluid flow; and
is sealed via a metal covering sheet of the cooling plate.

14. The process according to claim 13, further comprising, before fixing and thermal coupling the cooling plate and the structural component, coherently bonding the metal covering sheet of the cooling plate to the at least one channelled metal sheet of the cooling plate in a direction facing away from the joint.

15. A composite, comprising:
a cooling plate through which a temperature-control fluid is flowable;
a structural component amenable to cooling via the cooling plate; and
wherein the composite has been produced via the process according to claim 1.

16. The process according to claim 1, wherein full-surface adhesive bonding the cooling plate and the structural component to one another further includes:
melting the adhesive; and
while melting the adhesive, pressing the cooling plate and the structural component together with a force of 0.1 to 0.7 N/mm².

17. A composite, comprising:
a cooling plate including a channelled metal sheet, the channelled metal sheet including at least one groove-like depression that at least partially defines at least one fluid channel through which a temperature-control fluid is flowable;
a structural component coolable via the cooling plate; and
an adhesive disposed in a joint defined between the cooling plate and the structural component, the adhesive providing a full-surface adhesive bond that fixes and thermally couples the cooling plate and the structural component to one another.

18. The composite according to claim 17, wherein:
the at least one groove-like depression includes a plurality of groove-like depressions;
the at least one fluid channel includes a plurality of fluid channels;
the channelled metal sheet has a cross-sectional profile having a rectangular-wave shape that forms the plurality of groove-like depressions; and
the cooling plate further includes a metal covering sheet connected to the channelled metal sheet and closing the plurality of fluid channels in a direction towards the joint such that the channeled metal sheet and the metal covering sheet define an outer periphery of each of the plurality of fluid channels.

19. The composite according to claim 17, wherein the adhesive is structured as an adhesive film having a thickness of 10 to 100 micrometres.

20. The composite according to claim 17, wherein the adhesive is sandwiched directly between and completely coats (i) a joint-delimiting joint area of the cooling plate and (ii) a joint-delimiting joint area of the structural component.
